(19) United States
(12) Patent Application Publication
(10) Pub. No.: US 2017/0335901 A1
(43) Pub. Date: Nov. 23, 2017

(54) FLUID FRICTION CLUTCH

(71) Applicant: BorgWarner Inc., Auburn Hills, MI (US)

(72) Inventors: Thomas Buchholz, Stockach (DE); Wolfgang U. Sorg, Horgenzell (DE); Alexander Bahr, Inzigkofen (DE)

(21) Appl. No.: 15/671,239

(22) Filed: Aug. 8, 2017

Related U.S. Application Data
(63) Continuation of application No. PCT/US2016/018576, filed on Feb. 19, 2016.

(30) Foreign Application Priority Data
Feb. 20, 2015 (DE) 102015203064.4

(51) Int. Cl. F16D 35/02; F01P 7/04; F16D 47/06; F16D 25/065; F16D 48/02; F04B 23/02

(52) U.S. Cl. CPC F16D 35/026; F16D 47/06; F16D 25/065; F01P 7/042; F04B 23/025; F16D 35/027; F16D 25/14

(57) ABSTRACT

A fluid friction clutch with a housing, a clutch plate and a reservoir that are disposed in the housing, a supply pump element rotatably coupled to the clutch plate, a supply conduit and a valve. The clutch plate and the housing form a working chamber. The supply conduit couples the reservoir to an inlet side of the working chamber. The supply pump element has a pump inlet and a pump outlet that are spaced circumferentially apart from one another about a rotational axis of the clutch plate. The pump outlet is coupled in fluid communication with the supply conduit. The valve has a valve element that is movable between a first or extended position and a second or retracted position. Placement of the valve element in the first position at least partly blocks fluid flow to the pump outlet.

### CROSS-REFERENCE TO RELATED APPLICATIONS

This application is a continuation of PCT International Application No. PCT/US2016/018576 filed on Feb. 19, 2016, which claims the benefit and priority of German Patent Application No. DE102015203064.4, filed Feb. 20, 2015. The entire disclosure of each of the above applications is incorporated by reference as if fully set forth in detail herein.

### FIELD

The present disclosure relates to a fluid friction clutch.

### BACKGROUND

This section provides background information related to the present disclosure which is not necessarily prior art.

A fluid friction clutch of this type is known from DE 10 2010 043 264 A1. In this known fluid friction clutch, a separate component is provided in the form of an intermediate plate or partition for separating a working chamber from a reservoir. This partition is rigidly connected to the driven side, that is, to the housing of the clutch. This partition has at least one valve, generally however, it has two valves in order to control a fluid flow between the reservoir and the working chamber. Further, at least one baffle element is provided which is arranged at the gap, in order to cause a backpressure in the fluid using the rotational speed difference to support the fluid flow.

Due to the provision of this partition, however, the technical problem arises that the structural length of the entire clutch is substantially increased. This, in turn, has the disadvantage that built-up fluid friction clutches of this type cannot be used in restricted installation conditions.

### SUMMARY

This section provides a general summary of the disclosure, and is not a comprehensive disclosure of its full scope or all of its features.

A fluid friction clutch that includes a housing, a clutch plate rotatably disposed in the housing, a reservoir disposed in the housing, a supply conduit, a supply pump element, a supply pump element that is rotatably coupled to the clutch plate, and a valve arranged in the clutch plate. The clutch plate and the housing form a working chamber. The supply conduit couples the reservoir to an inlet side of the working chamber. The supply pump element is spaced radially apart from a surface on the housing such that a shear gap is disposed between the supply pump element and the surface on the housing. The supply pump element has a pump inlet and a pump outlet that are spaced circumferentially apart from one another about a rotational axis of the clutch plate. The pump outlet is coupled in fluid communication with the supply conduit. The valve has a valve element that is movable between a first position, in which the valve element extends from the clutch plate to at least partly block fluid flow to the pump outlet, and a second position in which the valve element is retracted into the clutch plate relative to the first position of the valve element.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a sectional view of a fluid friction clutch according to the invention;

FIG. 2 shows a sectional view of a part of the fluid friction clutch according to FIG. 1 at another point of the fluid friction clutch;

FIGS. 3 and 4 show a valve according to the invention of the fluid friction clutch according to the invention in the idle state and closed position, respectively;

FIGS. 5, 6 show the depiction according to FIGS. 3 and 4, respectively, in another sectional view of the valve according to the invention in the idle state and closed position, respectively; and

FIGS. 7, 8 show perspective depictions of a clutch plate of the fluid friction clutch according to the invention.

Corresponding reference numerals indicate corresponding parts throughout the several views of the drawings.

### DETAILED DESCRIPTION

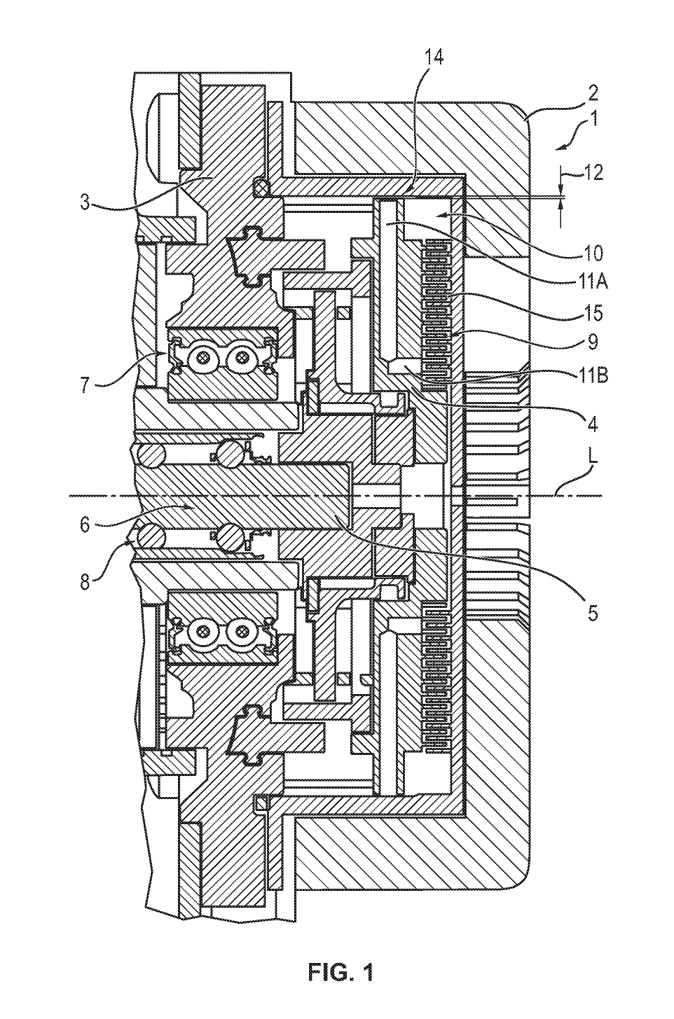

A clutch plate 4 is arranged in housing 2, 3 and is rotatable with respect to housing 2, 3. Clutch plate 4 is hereby connected rotatably fixed to an end 5 of a shaft 6 mounted centrally inside of housing 2, 3. At the other end of said shaft 6, not visible in FIG. 1, a drivable effective organ may be fixed, which may be designed for example as a pump wheel or as a compressor.

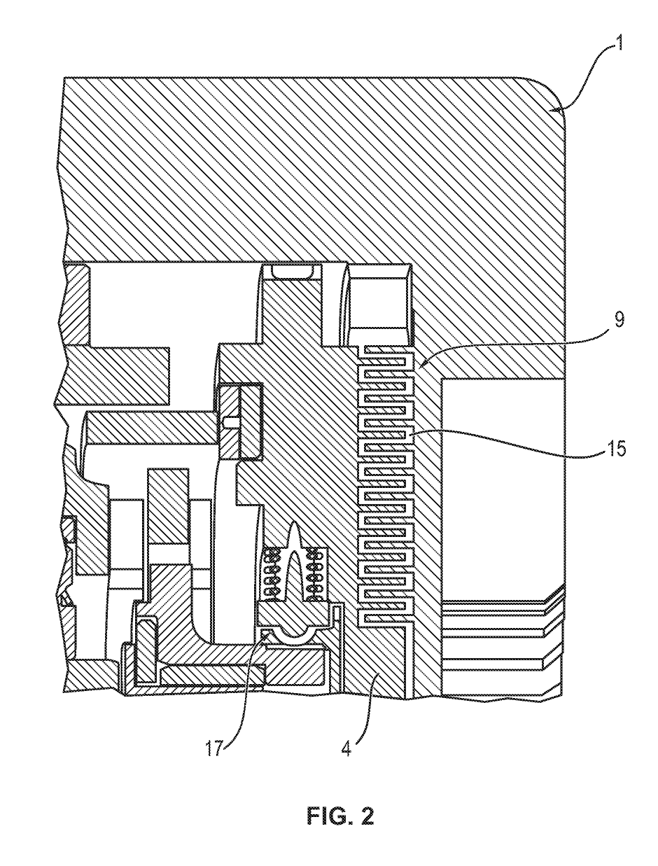

A working chamber 9 is arranged between housing 2, 3 and clutch plate 4 and has, as is clear from FIGS. 1 and 2, a working gap 15, which enables a torque transmission based on a shear effect on the clutch fluid supplied to the working chamber 9.

Further, a reservoir 10 is provided for the specified clutch fluid, wherein a supply channel 11A, 11B leads from reservoir 10 to working chamber 9 and thereby forms the supply.

As is clear in FIGS. 1 and 2, reservoir 10 is arranged outwardly, which means that reservoir 10 is arranged radially outside of working chamber 9 when viewed in the direction of the longitudinal central axis L of fluid friction clutch 1.

Further, fluid friction clutch 1 according to the invention may be provided with a return pump system or recirculation pump which functions to recirculate the clutch fluid from working chamber 9 to reservoir 10. This recirculation pump may also be integrated in clutch plate 4; however, it is not shown in the drawings. With respect to this, however, reference is made to the explanations in EP 2 679 850 A1, the contents of which disclosure are made part of the contents of the disclosure of the present application by explicit reference.

As arises primarily from an overview of FIGS. 1 to 4 and 7 and 8, fluid friction clutch 1 according to the invention is further provided with a supply pump element 14, which is integrated in clutch plate 4 and is thus mounted rotationally fixed on shaft 6, and is thus rotatable with respect to housing 2, 3, but not, however, with respect to shaft 6.

Supply pump element 14 has, in the exemplary case depicted, a shear gap 12 on the radial outer edge thereof, which gap is formed with respect to housing 2, 3.

Due to this arrangement, a conveying pump is formed which, due to a difference in speeds generated between supply pump element 14 and housing 2, 3, enables a volume flow of clutch fluid from reservoir 10 to working chamber 9.

The volume flow from reservoir 10 into working chamber 9 is generated by the previously mentioned supply pump element 14 in conjunction with shear gap 12. Supply pump element 14 and shear gap 12 hereby form a conveying pump; the functional principle thereof is based on a difference in rotational speeds.

To control the supply of clutch fluid to supply pump element 14, a valve 17 is integrated in clutch plate 4, for which purpose clutch plate 4 has an accommodation recess 21, which is identified in FIG. 4 as representative for all accommodation recesses of the different embodiments.

Valve 17 comprises specifically a valve pin 13, which is arranged in the radial direction R of clutch plate 4 in correspondence with the orientation of accommodation recess 21.

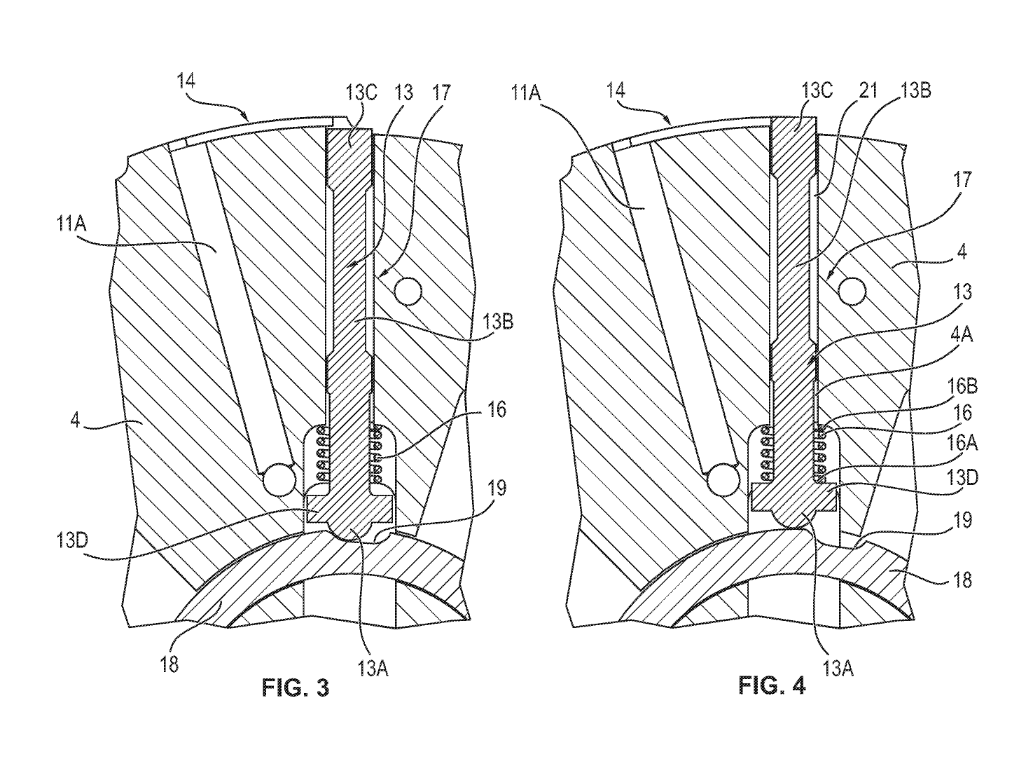

Valve pin 13 has a pin head 13A, which is in operative connection to an actuator 18. In the embodiment according to FIGS. 3 and 4, actuator 8 is a rotatable plate with an accommodation recess 19, into which pin head 13A plunges in the idle position depicted in FIG. 3. The additionally provided spring 16, which enables a fail-safe function, is provided for the purpose of pressing pin head 13A into recess 19, according to the depiction in FIG. 3, so that the diametrically opposite end 13C releases supply pump element 14, as is clear from FIG. 3. This end 13C is an end region of pin shaft 13B which is guided in accommodation recess 21. Further, a pin plate 13D is arranged between pin shaft 13B and pin head 13A. An end 16A of spring 16 is supported on this pin plate 13D, while the diametrically opposite end 16B of spring 16 is supported on a wall region 4A of clutch plate 4, as is clear from the depiction in FIG. 4.

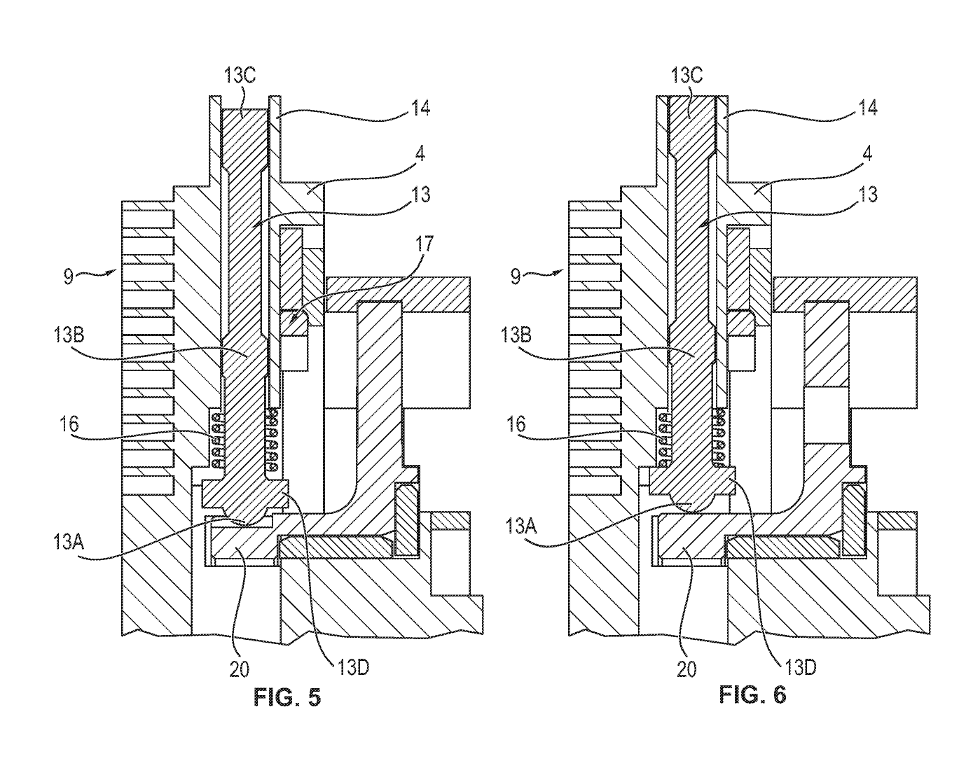

FIGS. 5 and 6 show only another sectional view of the arrangement according to FIGS. 3 and 4, from which an actuator 20 is visible, which moves pin head 13A between the idle state and the closed position due to a radial movement on the same.

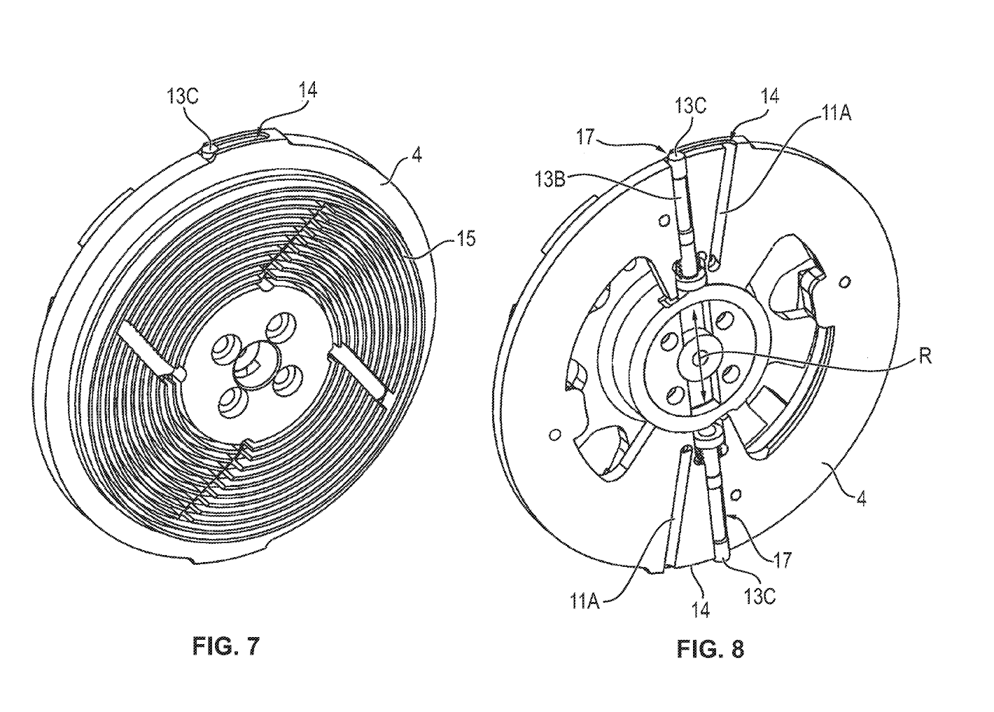

FIGS. 7 and 8 illustrate perspective representations of clutch plate 4, wherein, form an overview of said FIGS. 7 and 8, the radial direction R of valve 17 or valve pin 13 is clear. From the representation in FIG. 8, it is further clear that it is also possible to integrate two valves 17 into clutch plate 4.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fluid friction clutch (1) comprising:
a housing (2, 3);
a clutch plate (4) rotatably disposed in the housing (2,3), the clutch plate (4) and the housing (2, 3) forming a working chamber (9);
a reservoir (10) disposed in the housing (2, 3);
a supply conduit (11A, 11B) coupling the reservoir to an inlet side of the working chamber (9);
a supply pump element (14) that is rotatably coupled to the clutch plate (4), the supply pump element (14) being spaced radially apart from a surface on the housing (2, 3) such that a shear gap (12) is disposed between the supply pump element (14) and the surface on the housing (2, 3), the supply pump element (14) having a pump inlet and a pump outlet that are spaced circumferentially apart from one another about a rotational axis of the clutch plate (4), the pump outlet being coupled in fluid communication with the supply conduit (11A, 11B);
a valve (17) arranged in the clutch plate (4), the valve (17) having a valve element (13) that is movable between a first position, in which the valve element (13) extends from the clutch plate (4) to at least partly block fluid flow to the pump outlet, and a second position in which the valve element (13) is retracted into the clutch plate (4) relative to the first position of the valve element (13).

2. The fluid friction clutch (1) of claim 1, wherein the valve element (13) is a pin arranged in the radial direction of the clutch plate (4).

3. The fluid friction clutch (1) of claim 2, wherein the valve element (13) comprises a pin head (13A) that is in operative connection with an actuator (18, 20) that is configured to selectively move the valve element (13) between the first and second positions.

4. The fluid friction clutch (1) of claim 3, wherein the pin head (13A) is arranged on a pin shaft (13B) which has a pin end (13C) arranged diametrically opposite to the pin head (13A) and which pin end (13A) projects radially outwardly from the clutch plate (4) in at least one of the first and second positions of the valve element (13).

5. The fluid friction clutch (1) of claim 4, wherein a pin plate (13D) is arranged between the pin head (13A) and the pin shaft (13B), wherein a spring (16) is disposed on the valve element (13), and wherein opposite ends of the spring (16) abut the pin head (13A) and a wall region (4A) of the clutch plate (4).

6. The fluid friction clutch (1) of claim 1, further comprising a spring (16) disposed between the valve element (13) and the clutch plate (4).

7. The fluid friction clutch (1) of claim 6, wherein the spring (16) biases the valve element toward the second position.

8. The fluid friction clutch (1) of claim 1, further comprising an actuator (18, 20) that is selectively operable for moving the valve element (13) between the first and second positions.

9. The fluid friction clutch (1) of claim 8, wherein the actuator (18, 20) is rotatable relative to the valve element (13).

10. The fluid friction clutch (1) of claim 9, wherein the actuator (18, 20) defines a recess (19) into which the valve element (13) is received when the valve element (13) is in the second position.

11. The fluid friction clutch (1) of claim 1, wherein the pump inlet is disposed circumferentially about the clutch plate (4) at a location between the pump outlet and an end (13C) of the valve element (13) that projects from the clutch plate (4) when the valve element (13) is in the first position.

12. The fluid friction clutch (1) of claim 1, wherein the supply conduit (11A, 11B) has a conduit portion (11A) that extends in a radial direction relative to a rotational axis of the clutch plate (4) and wherein the valve element (13) is spaced circumferentially apart from the conduit portion (11A).

13. The fluid friction clutch (1) of claim 1, wherein the valve element (13) is disposed in the clutch plate (4) at a location that is circumferentially spaced apart from the supply conduit (11A, 11B).

14. The fluid friction clutch (1) of claim 1, further comprising a shaft (5) that is received in the housing (2, 3), the shaft (5) being rotatably coupled to the clutch plate (4).
